(19) United States
(12) Patent Application Publication
(10) Pub. No.: US 2010/0043284 A1
(43) Pub. Date: Feb. 25, 2010

(54) SELF-ADJUSTING PLANT SUPPORT SYSTEM

(76) Inventors: Tasha L. Smith, Gary, IN (US); Alphonso Rogers, Merrillville, IN (US); Melvin L. Smith, Gary, IN (US)

Correspondence Address: HARTMAN & HARTMAN, P.C., 552 EAST 700 NORTH, VALPARAISO, IN, 46383, US

(21) Appl. No.: 12/485,629

(22) Filed: Jun. 16, 2009

Related U.S. Application Data
(60) Provisional application No. 61/061,763, filed on Jun. 16, 2008.

(51) Int. Cl. A01G 9/12

(52) U.S. Cl. 47/70; 47/46

(57) ABSTRACT

A plant support system that is self-adjusting in height to accommodate growth of a plant, and a method of using such a system. The system includes a pole assembly having a base and first and second pole sections. The base is sized to be received in a container, the first pole section is coupled to the base of the pole assembly, and the second pole section is coupled to the first pole section so as to enable the second pole section to longitudinally extend and retract relative to the first pole section while remaining coupled to the first pole section. Features are disposed on at least the second pole section for releasably securing portions of a plant longitudinally extending alongside the pole assembly. The container is preferably supported by a turntable to rotate about its axis of symmetry.

### CROSS REFERENCE TO RELATED APPLICATIONS

This application claims the benefit of U.S. Provisional Application No. 61/061,763, filed Jun. 16, 2008, the contents of which are incorporated herein by reference.

### BACKGROUND OF THE INVENTION

The present invention generally relates to potted plant containers of the type used to contain household potted plants. More particularly, this invention relates to a potted plant container with a support assembly that is self-adjusting in height as the plant grows.

Various plant containers have been proposed that have the ability to provide vertical support for tall plants. For example, U.S. Pat. No. 6,209,258 to Schneider discloses a plant container that equipped with a rod or pole that can be threaded into female threads formed in a boss (socket) on a plate placed in the base of a container. The rod allows for additional rods to be added to increase its overall height, and allows for wedges to be placed “evenly along the length of the rod and around the periphery of the rod” for the purpose of providing locations for securing string ties along the length of the rod. Schneider also discloses the use of a rigid “plant support loop” or hooks. U.S. Pat. No. 4,881,342 to Ferguson discloses the use of hooks installed on a pole to support a plant, secure the plant stem or stalk, and ensure that the plant grows upwards. U.S. Pat. No. 6,408,569 to Obregon discloses a plate shaped to fit within the lower portion of a conventional pot, and a rigid rod to support the stem, stalk or trunk of a plant.

### BRIEF DESCRIPTION OF THE INVENTION

The present invention provides a plant support system that is self-adjusting in height to accommodate growth of a plant, and to a method of using such a system.

According to a first aspect of the invention, the self-adjusting plant support system is adapted for use with a plant container having a base and a peripheral wall extending from the base to define a receptacle therein that is adapted to retain a potting material. The plant support system includes a pole assembly that defines a longitudinal axis and includes a base and first and second pole sections. The base is sized to be received in the receptacle of the container when disposed adjacent the base of the container. The first pole section is coupled to the base of the pole assembly, and the second pole section is coupled to the first pole section so as to enable the second pole section to longitudinally extend and retract relative to the first pole section while remaining coupled to the first pole section. Means is disposed on at least the second pole section for releasably securing portions of a plant longitudinally extending alongside the pole assembly. The pole assembly is adapted so that a plant that is rooted in a potting material disposed in the receptacle of the container and longitudinally extends along the pole assembly can be secured with the securing means and cause the second pole section of the pole assembly to longitudinally extend from the first pole section as the plant grows.

Another aspect of the invention is to provide the container as part of the plant support system. The pole assembly is placed in the container so that the base of the pole assembly is disposed adjacent the base of the container. A potting material can be placed in the receptacle of the container, and a plant can be rooted in the potting material to longitudinally extend along the pole assembly. The potting material is preferably capable of being the sole means by which the base of the pole assembly is secured within the container.

Yet another aspect of the invention is a method of self-adjustably supporting a plant with the self-adjusting plant support system. The method includes rooting a plant in a potting material disposed in the receptacle of the container, securing the plant to at least the second pole section of the pole assembly with the securing means, and allowing the plant to grow longitudinally along the pole assembly, wherein as the plant grows the plant causes the second pole section to longitudinally extend relative to the first pole section.

A preferred aspect of the invention is to further include means that enables the container to rotate about an axis of symmetry thereof. More preferably, the container is supported by a turntable, which may be disposed between the base of the container and a pan in which the container is placed.

Other aspects and advantages of this invention will be better appreciated from the following detailed description.

### BRIEF DESCRIPTION OF THE DRAWINGS

FIG. 1 shows a lower pole section of a pole assembly suitable for supporting a plant within a plant container in accordance with a first embodiment of this invention.

FIG. 2 shows an upper pole section of the pole assembly and adapted to be assembled with the lower pole section of FIG. 1.

FIG. 3 is a plan view of a base of the pole assembly and adapted to be assembled with the lower pole section of FIG. 1.

FIG. 4 shows the lower and upper pole sections of FIGS. 1 and 2 assembled and supporting two plants within a plant container configured in accordance with an optional aspect of the invention.

FIG. 5 is a partial sectional view of the lower end of the plant container of FIG. 4.

FIGS. 6 and 7 contain two elevational views oriented ninety degrees apart, and show a pole assembly and plant container in accordance with a preferred embodiment of this invention.

FIG. 8 represents a cross-sectional view along section line 8-8 of FIG. 7.

FIG. 9 is a plan view of the pole assembly and plant container of FIGS. 6 and 7.

FIG. 10 represents a cross-sectional view along section line 10-10 of FIG. 7.

FIG. 11 represents a detailed cross-sectional view of the container of FIG. 7.

### DETAILED DESCRIPTION OF THE INVENTION

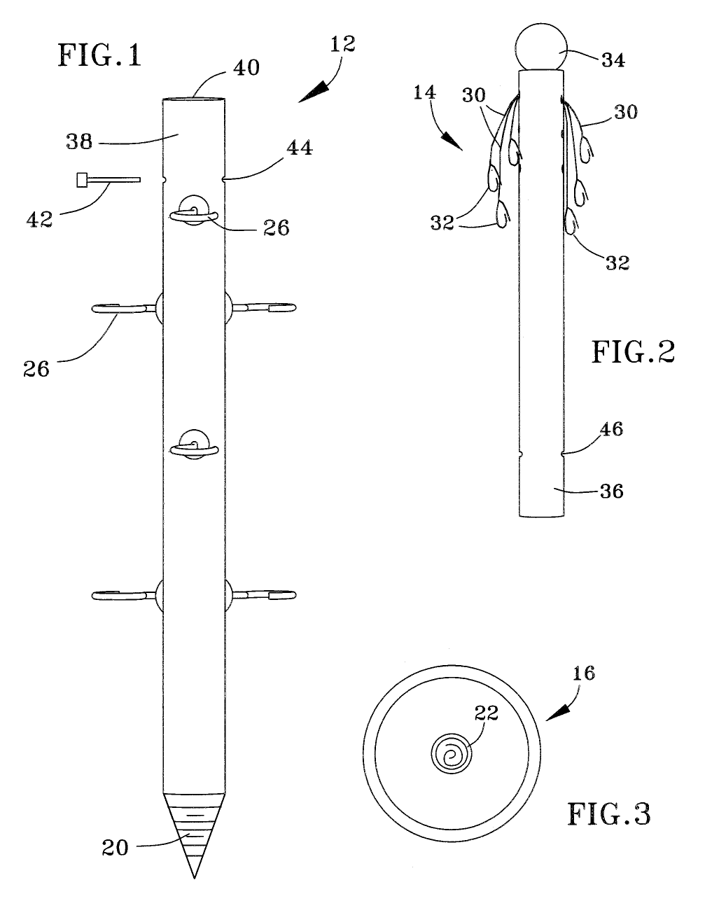

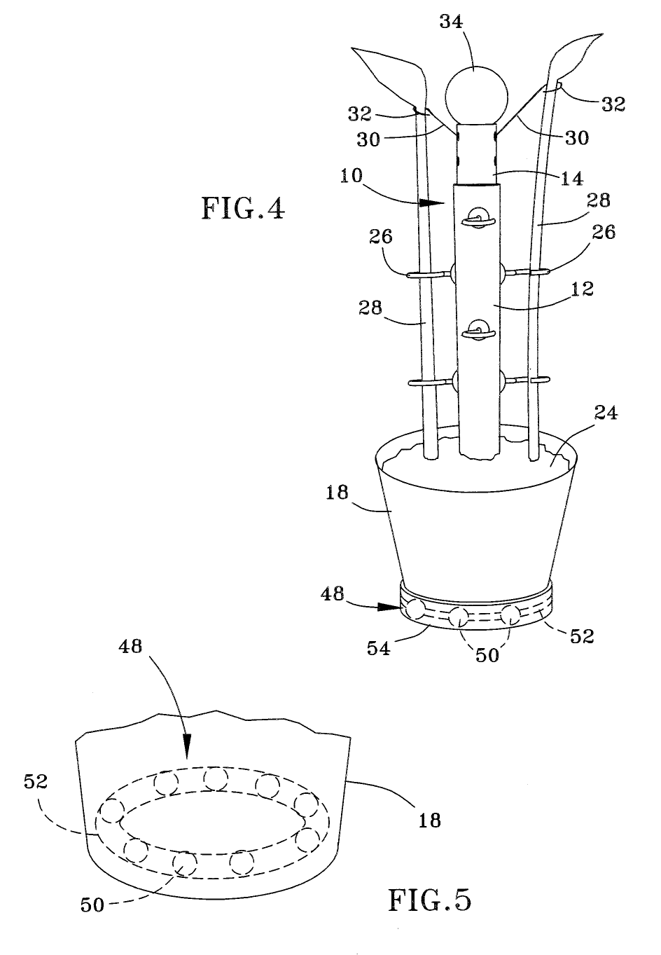

FIGS. 1 through 5 represent a first embodiment of the invention. FIGS. 1, 2 and 3 represent, respectively, a lower pole section 12, an upper pole section 14, and a base 16 of a pole assembly 10 shown in FIG. 4 as placed in a plant container (pot) 18. The container 18 is represented as being of a type suitable for containing household plants, and particularly plants that tend to grow upward and benefit from lateral and vertical support. The lower pole section 12 is shown as having a lower threaded end 20 sized and adapted to thread into a threaded boss 22 on the base 16. The end 20 of the lower pole section 12 may be locked into place on the base 16, for example, with a locking pin (not shown) that passes through the end 20 and boss 22. The base 16 is sized to be received in the container 18, and more particularly to be placed adjacent a base (not shown) of the container 18, such that a potting material 24 placed in the container 18 is able to secure the base 16 of the pole assembly 10 within the container 18. For example, the base 16 preferably extends at least 50% and more preferably at least 75% of the diametrical width of the container 18 at its base.

As represented in FIG. 4, the upper pole section 14 is preferably adapted to be telescopically assembled with the lower pole section 12 through an opening 40 at the upper end of the lower pole section 12. In FIG. 4, at least the lower portion 36 of the upper pole section 14 is sized to be received in at least the upper portion 38 of the lower pole section 12. In this manner, the upper pole section 14 is coaxial with the lower pole section 12 and can be longitudinally extended and retracted relative to the lower pole section 12, enabling the length (height) of the pole assembly 10 to be adjusted to accommodate various heights of household plants. While the arrangement of FIG. 4 is preferred, other assembly configurations are also foreseeable, such as sizing the lower pole section 12 to be telescopically received in the upper pole section 14, or configuring the upper pole section 14 to be secured in a longitudinal channel in the exterior surface of the lower pole section 12, etc.

With the preferred telescoping configuration, the pole sections 12 and 14 can be conveniently fabricated from polyvinyl chloride (PVC) pipe or the like. Suitable but nonlimiting dimensions for the pole assembly 10 include an outer diameter of about ¾ inch (about 2 cm) for the lower pole section 12, an outer diameter of about ½ inch (about 1.5 cm) for the upper pole section 12, a length of about four feet (about 120 cm) for the lower pole section 12, a length of about three feet (about 90 cm) for the upper pole section 12, and a diameter of about six to twenty-four inches (about 15 to 60 cm) for the base 16.

The lower pole section 12 is represented as having a number of hooks 26 placed around its perimeter and along its length. The hooks 26 are adapted to secure the leaves and/or stems of one or more plants to the pole assembly 10, as represented by the plants 28 in FIG. 4. The hooks 26 are preferably provided in diametrically-opposed pairs, though other configurations are foreseeable. The upper pole section 14 is provided with a number of cords 30 near its upper end 34. The cords 30 can be formed of fishing line or any other durable material. The cords 30 are shown equipped with clips 32 that are capable of being attached to the stems and/or leaves of a plant, as shown in FIG. 4. Because of the telescoping arrangement of the lower and upper pole sections 12 and 14, the upper pole section 14 is caused to extend longitudinally from the lower pole section 12 as the plants 28 grow upward and draw the cords 30 upward therewith. The lower and upper pole sections 12 and 14 may be secured together within a pin 42 inserted into alignable holes 44 and 46 in the lower and upper pole sections 12 and 14, respectively.

The container 18 is represented in FIGS. 4 and 5 as being adapted to rotate. For this purpose, the container 18 is shown equipped with a turntable 48 comprising bearings 50 within a retainer ring or pan 52, which support the container 18 and enable the container 18 to rotate about its axis of symmetry. Because of the likely minimal weight of the pole assembly 10, container 18, potting material 24 and plants 28, the bearings 50 can be marbles or any other suitably round and hard material that is widely available and preferably inexpensive. The turntable 48 enables the container 18 to be easily rotated, simplifying adjustments to the container 18 to allow for uniform plant exposure to sunlight. The turntable 48 is shown as being disposed between the base of the container 18 and a pan 54, which can be of a type widely used to collect water when the plants 28 are watered. In this embodiment, the use of marbles as the bearings 50 is advantageous since marbles will not corrode when contacted by water over extended periods.

In use, the pole assembly 10 can be assembled and its base 16 placed in the bottom of the container 18, after which the potting material 24 can be placed in the container 18 and the plants 28 rooted in the potting material 24. The plants 28 are then secured to at least the upper pole section 14 and preferably both pole sections 12 and 14 of the pole assembly 10 with the hooks 26 and cords 30. Thereafter, as the plants 28 grow upward and longitudinally along the pole assembly 10, the upper pole section 14 longitudinally extends from the lower pole section 112. The base 16 of the pole assembly 10 supports the potting material 24 within the container 18, and the potting material 24 can serve as the sole means for securing the pole assembly 10 to the container 18.

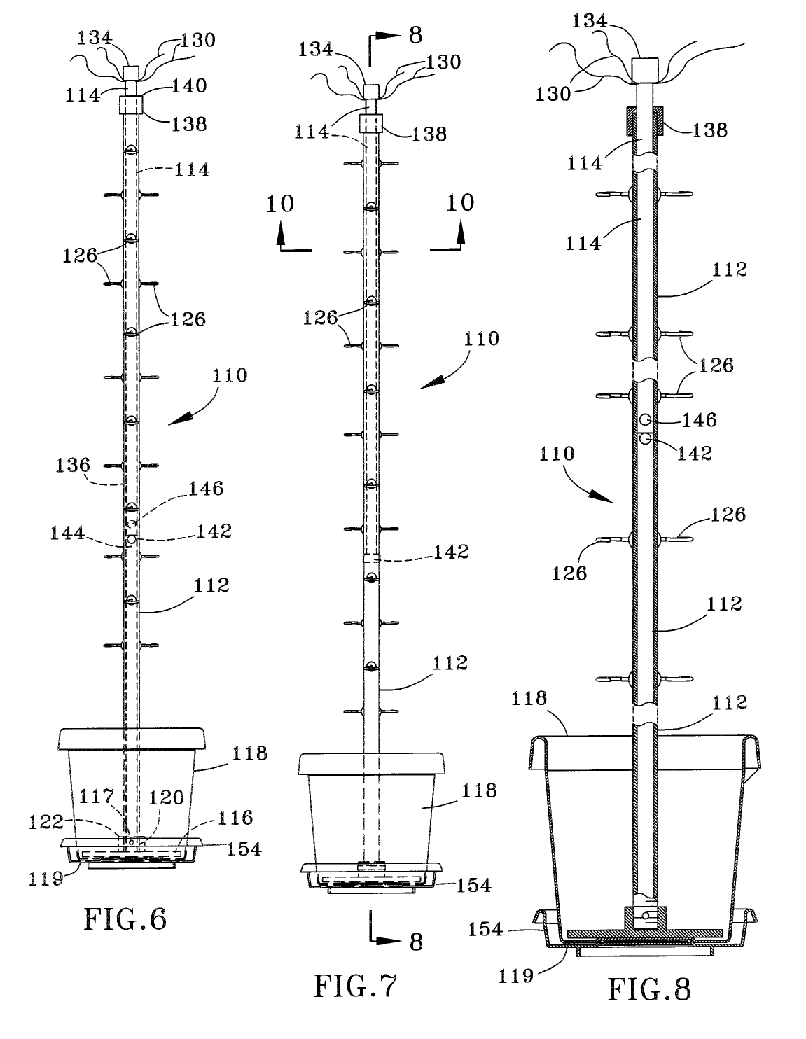

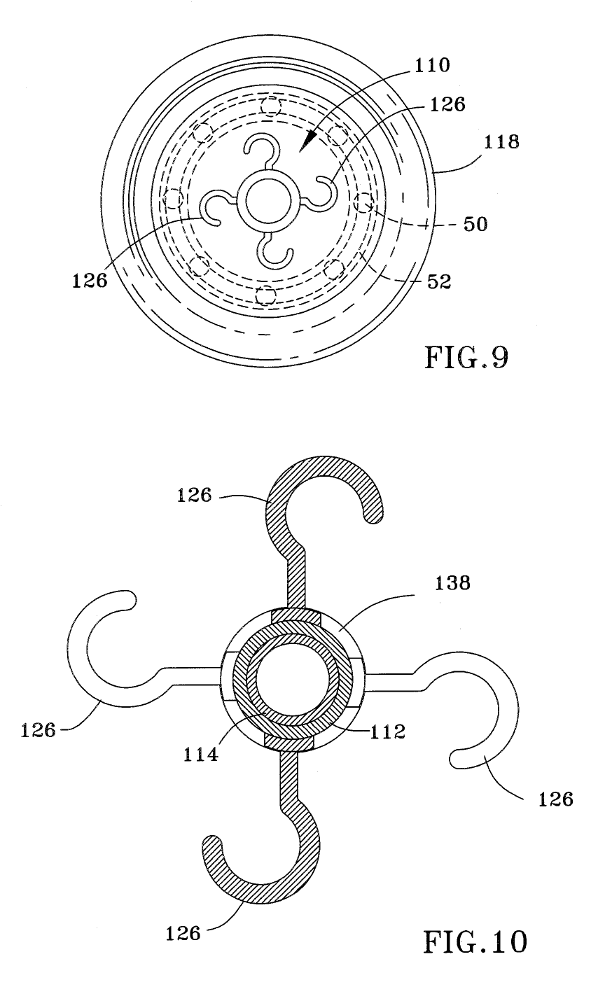

FIGS. 6 through 11 represent a second embodiment of the invention, which is represented as comprising a pole assembly 110 having a similar construction to the pole assembly 10 of FIGS. 1, 2 and 3. In view of similarities between the first and second embodiments, the following discussion of the second embodiment will focus primarily on aspects of the second embodiment that significantly differ from the first embodiment. Other aspects of the second embodiment not discussed in any detail can be, in terms of structure, function, materials, etc., essentially as was described for the first embodiment.

As in the first embodiment, the pole assembly 110 of the second embodiment includes a lower pole section 112, an upper pole section 114, and a base 116 that are placed in a plant container (pot) 118. In addition, the lower pole section 112 has a lower threaded end 120 threaded into a threaded boss 122 on the base 116. The end 120 of the lower pole section 112 is shown locked in place on the base 116 with a locking pin 117 that passes through the end 120 and boss 122. The base 116 is shown received in the container 118 and located adjacent the base 119 of the container 118, such that a potting material (not shown) placed in the container 118 secures the base 116 of the pole assembly 110 within the container 118 as previously described.

As with the first embodiment, the upper pole section 114 is telescopically assembled with the lower pole section 112, enabling the upper pole section 114 to freely longitudinally extend and retract relative to the lower pole section 112 to accommodate various heights of household plants (not shown). Again, arrangements other than the telescoping arrangement seen in FIGS. 6 through 8 are foreseeable. In FIGS. 6 through 8, the upper pole section 114 is shown passing through an opening 140 defined in a cap 138 at the upper end of the lower pole section 112. The lower pole section 112 has a number of hooks 126 bonded to its perimeter and along its length to secure the leaves and/or stems of one or more plants to the pole assembly 110. The upper pole section 114 is provided with a number of cords 130 near its upper end 134 that are capable of being attached to the stems and/or leaves of a plant. Because of the telescoping arrangement of the lower and upper pole sections 112 and 114, the upper pole section 114 extends longitudinally from the lower pole section 112 as a plant secured to the cords 130 grows upward, with the result that the pole assembly 110 is self-adjusting in height. The lower and upper pole sections 112 and 114 can be secured together within a pin 142 inserted into alignable holes 144 and 146 in the lower and upper pole sections 112 and 114, respectively. The pin 142 and holes 144 and 146 can also be used to limit the retraction of the upper pole section 114 into the lower pole section 112 by inserting the pin 142 through the holes 144 only and allowing the lower end of the upper pole section to rest on the pin 142, as shown in FIGS. 6 through 8.

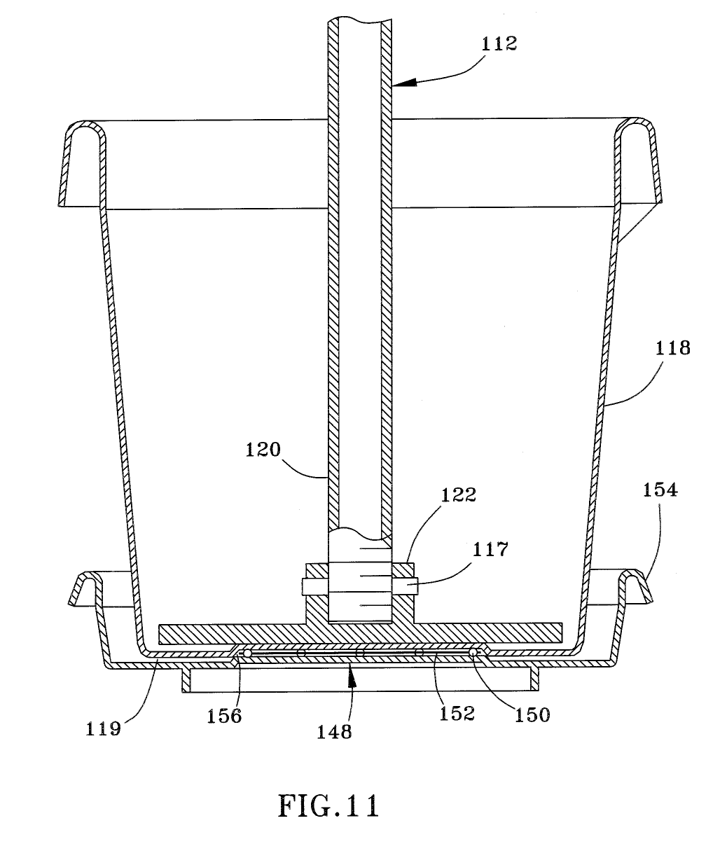

The container 118 is again adapted for rotation with the use of a turntable 148. In the embodiment of FIGS. 6 through 11, the base 119 of the container 118 is defined to have a recess 156 (FIG. 11) in which the bearings 150 and retainer ring 152 are received. The turntable 148 is disposed between the base 119 of the container 118 and a pan 154, such that the container 118 rotates relative to the pan 154.

While the invention has been described in terms of specific embodiments, it is apparent that other forms could be adopted by one skilled in the art. For example, the physical configurations of the pole assemblies 10 and 110 could differ from those shown, and materials and processes other than those noted could be used. It should also be noted that the drawings are drawn for illustrative purposes when viewed in combination with the description, and therefore are not necessarily to scale. Therefore, the scope of the invention is to be limited only by the following claims.

1. A self-adjusting plant support system for use with a plant container having a base and a peripheral wall extending from the base to define an receptacle therein that is adapted to retain a potting material, the self-adjusting plant support system comprising a pole assembly defining a longitudinal axis, the pole assembly comprising:
a base adapted to be received in the receptacle of the plant container and disposed adjacent the base of the container;
a first pole section coupled to the base of the pole assembly;
a second pole section coupled to the first pole section so as to enable the second pole section to longitudinally extend and retract relative to the first pole section while remaining coupled to the first pole section; and
means disposed on at least the second pole section for releasably securing portions of a plant longitudinally extending alongside the pole assembly;
wherein the pole assembly is adapted so that a plant that is rooted in a potting material disposed in the receptacle of the container and that is longitudinally extending along the pole assembly can be secured with the securing means and cause the second pole section of the pole assembly to longitudinally extend from the first pole section as the plant grows.

2. The self-adjusting plant support system according to claim 1, wherein the securing means comprises cords located adjacent an end of the second pole section farthest disposed from the first pole section of the pole assembly.

3. The self-adjusting plant support system according to claim 1, wherein the securing means comprises a plurality of hooks located along the length of the first pole section of the pole assembly.

4. The self-adjusting plant support system according to claim 3, wherein the hooks are arranged in radially-opposite pairs of hooks.

5. The self-adjusting plant support system according to claim 1, wherein the second pole section is telescopically received in the first pole section.

6. The self-adjusting plant support system according to claim 1, further comprising means for connecting the second pole section to the first pole section so as to prevent longitudinal movement of the second pole section relative to the first pole section.

7. The self-adjusting plant support system according to claim 6, wherein the connecting means comprises diametrically alignable holes in the first and second pole sections and a pin receivable in the holes to prevent longitudinal movement of the second pole section relative to the first pole section.

8. The self-adjusting plant support system according to claim 1, further comprising means for adjustably limiting the longitudinal retraction of the second pole section relative to the first pole section while enabling the second pole section to longitudinally extend relative to the first pole section,

9. The self-adjusting plant support system according to claim 8, wherein the adjustable limiting means comprises diametrically alignable holes in the first pole section and a pin receivable in the holes for vertically supporting the second pole section.

10. The self-adjusting plant support system according to claim 1, further comprising the container having the base, the peripheral wall extending from the base, and the receptacle defined therein for retaining a potting material.

11. The self-adjusting plant support system according to claim 10, further comprising means for enabling the container to rotate about an axis of symmetry thereof.

12. The self-adjusting plant support system according to claim 11, wherein the rotation-enabling means comprises a turntable and bearings supported by the turntable and adapted to engage the container.

13. The self-adjusting plant support system according to claim 12, wherein the bearings support the base of the container.

14. The self-adjusting plant support system according to claim 11, wherein the rotation-enabling means further comprises a pan in which the container is received and the rotation-enabling means is disposed between the pan and the base of the container to enable the container to rotate relative to the pan.

15. The self-adjusting plant support system according to claim 10, wherein the pole assembly is assembled with the container so that the base of the pole assembly is disposed adjacent the base of the container, a potting material is disposed in the receptacle of the container, a plant is rooted in the potting material and longitudinally extends along the pole assembly, and the base of the pole assembly is secured within the container by the potting material.

16. A method of self-adjustably supporting a plant with the self-adjusting plant support system of claim 1, the method comprising:
rooting a plant in a potting material disposed in the receptacle of the container;
securing the plant to at least the second pole section of the pole assembly with the securing means; and
allowing the plant to grow longitudinally along the pole assembly, wherein as the plant grows the plant causes the second pole section to longitudinally extend relative to the first pole section.

17. The method according to claim 16, further comprising securing the plant to a plurality of hooks located along the length of the first pole section of the pole assembly.

18. The method according to claim 16, wherein the second pole section telescopically extends from the first pole section as the plant grows.

19. The method according to claim 16, wherein the base of the pole assembly supports the potting material within the receptacle of the container and the potting material is the sole means for securing the pole assembly to the container.

20. The method according to claim 16, further comprising supporting the container with a turntable and rotating the container on the turntable about an axis of symmetry thereof.

21. The method according to claim 20, wherein the container is received in a pan and the turntable is disposed between the pan and the base of the container to enable the container to rotate relative to the pan.
